(19) United States
(12) Patent Application Publication
(10) Pub. No.: US 2005/0200745 A1
(43) Pub. Date: Sep. 15, 2005

(54) Pop-up flash for photographing apparatus

(75) Inventor: Dong-Seok Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/059,320

(22) Filed: Feb. 17, 2005

(30) Foreign Application Priority Data
Mar. 10, 2004 (KR) 2004-16049

(51) Int. Cl. H04N 5/222

(52) U.S. Cl. 348/371; 348/376

(57) ABSTRACT

A pop-up flash for a photographing apparatus is provided. The pop-up flash includes a flash body to emit an illuminating light. The flash body is movable between a retracted position and a raised position. The pop-up flash further includes a locking lever having a locking boss which engages an engaging member formed at one of the flash body and a body of the photographing apparatus. Thus, when the flash body is positioned at the retracted position, and installed to the other of the flash body and the body of the photographing apparatus, the flash body may pivotally move between a first position at which the locking boss is engaged to the flash body and a second position at which the locking boss is released from the flash body. Furthermore, a resilient member urges the flash body in a pop-up direction. A locking member is provided to lock the locking lever when the flash body is positioned at the retracted position and to release the locking lever when the flash body is positioned at the raised position. The locking member is urged toward the second position when the locking boss contacts with the flash body and popped up by the resilient member when the flash body is positioned at the raised position.

### CROSS-REFERENCE TO RELATED APPLICATION

This application claims the benefit under 35 U.S.C. § 119(a) of Korean Patent Application No. 2004-16049, entitled “Flash Pop-Up Device for Photographing Apparatus,” filed Mar. 10, 2004, the entire disclosure of which is hereby incorporated by reference.

### BACKGROUND OF THE INVENTION

1. Field of Invention

The present invention relates to a photographing apparatus. More particularly, the present invention relates to a pop-up flash capable of moving a flash body to emit an illuminating light toward an object.

2. Description of the Related Art

In general, a photographing apparatus, such as camcorder, digital still camera, or conventional camera takes a photograph of a subject to produce still or moving images. The photographing apparatus typically includes a flash device which has a light emitting portion to emit an illuminating light toward the object. The flash device emits a certain quantity of light depending upon the brightness of an area surrounding the subject. The flash device includes an external flash detachably mounted on an upper portion of a body of the photographing apparatus, a built-in flash, or a pop-up flash movable between a retracted position and a raised position. In particular, in order to improve portability, the tendency is toward the use of the pop-up flash. The pop-up flash is linked to the body of the photographing apparatus by a linkage mechanism that moves the pop-up flash between the retracted and raised positions.

The pop-up flash comprises various shapes. In order to minimize the size of the photographing apparatus, a linkage mechanism was developed to pivot the flash body in a space.

However, a drawback of conventional pop-up flashes is that a pair of locking members must be linked to selectively lock the flash body, and an additional elastic spring is utilized to restore the locking members. As such, there is a problem in that its construction is relatively complicated.

Accordingly, there is a need for an improved pop-up flash for a flash body that emits an illuminating light toward an object and reduces the number of parts and simplifies operation.

### SUMMARY OF THE INVENTION

An aspect of the present invention is to solve at least the above problems and/or disadvantages and to provide at least the advantages described below. Accordingly, an aspect of the present invention is to provide an improved pop-up flash for a photographing apparatus capable of reducing the number of processes and components.

According to one aspect of the present invention, there is provided a pop-up flash for a photographing apparatus including a flash body to emit an illuminating light. The flash body is movable between retracted and raised positions. A locking lever has a locking boss which is engaged to an engaging member formed on one of the flash body and a body of the photographing apparatus. Thus, when the flash body is positioned at the retracted position, and installed to the other of the flash body and the body of the photographing apparatus, the flash body pivotally moves between a first position at which the locking boss is engaged to the flash body and a second position at which the locking boss is released from the flash body. A resilient member urges the flash body to the raised position. The device further includes a locking member to lock the locking lever when the flash body is positioned at the retracted position. The locking member is urged toward the second position by the locking boss contacting with the flash body to be popped up by the resilient member when the flash body is positioned at the raised position.

Therefore, an additional resilient member to restore the locking lever and linkage mechanism for the locking lever are advantageously not needed.

According to another aspect of the present invention, the locking boss has an engaging groove coupled to the engaging member when the flash body is substantially completely positioned at the retracted position. The engaging groove has a first inclined surface to urge the locking lever toward the second position to contact with the engaging member when the flash body is moved to the raised position.

It is also preferable that the engaging member include a locking pin to resiliently move between a third position at which the locking pin is inserted into the engaging groove and a fourth position at which the locking pin is released from the engaging groove. The locking boss has a second inclined surface to contact and guide the locking pin to the fourth position when the flash body is moved to the retracted position. Thus, a resilient force of the locking pin is substantially increased before the locking pin is inserted into the engaging groove.

In further accordance with an exemplary embodiment the locking lever is installed in the body of the photographing apparatus, and has a return piece that protrudes from a side of the locking lever. The return piece urges the locking lever to the first position by contacting with the flash body to be popped up in a state where the locking boss is released from the flash body.

It is also preferred that the locking member includes a solenoid coupled to one side of the locking lever to lock the locking lever when the locking lever is positioned at the first position and to release the locking lever while the locking lever is moved to the raised position.

It is also preferable that the pop-up flash further include a sensor installed to the body of the photographing apparatus to determine whether the flash body is positioned at the retracted position. The solenoid selectively locks the locking lever according to a signal of the sensor.

It is further preferable that the pop-up flash further include a pop-up frame installed in the body of the photographing apparatus to pivotally support the flash body and the locking lever. Preferably, the pop-up frame is shaped by molding.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

The above and other objects, and features, and advantages of certain embodiments of the present invention will be more apparent from the following description taken in conjunction with the accompanying drawings, in which:

FIG. 1 is a perspective view of a photographing apparatus including a pop-up flash according to an embodiment of the present invention;

FIG. 2 is a perspective view of a pop-up flash in accordance with another embodiment of the present invention;

FIG. 3 is an exploded perspective view of the pop-up flash in FIG. 2;

FIG. 4 is a side view of the locking boss in FIG. 2; and

FIG. 5 is a top view depicting an operation of the pop-up flash in FIG. 2.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

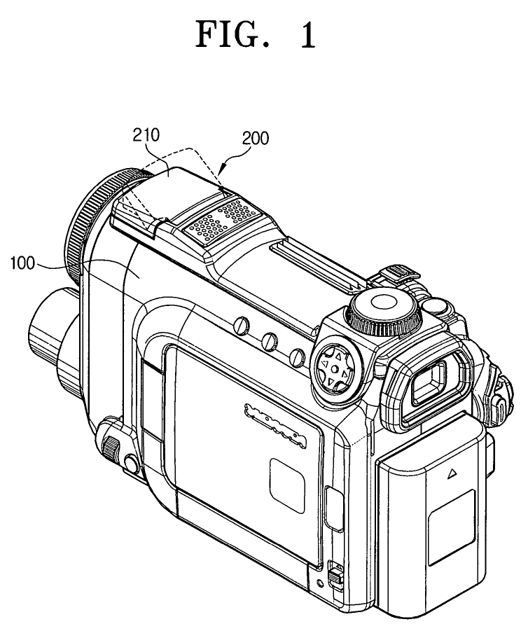

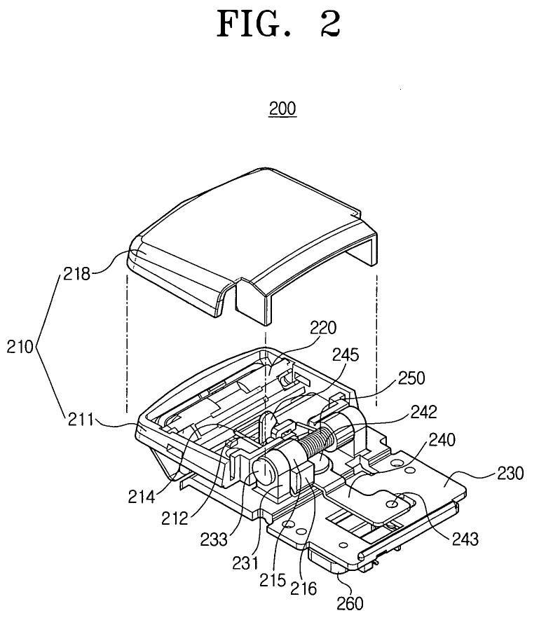

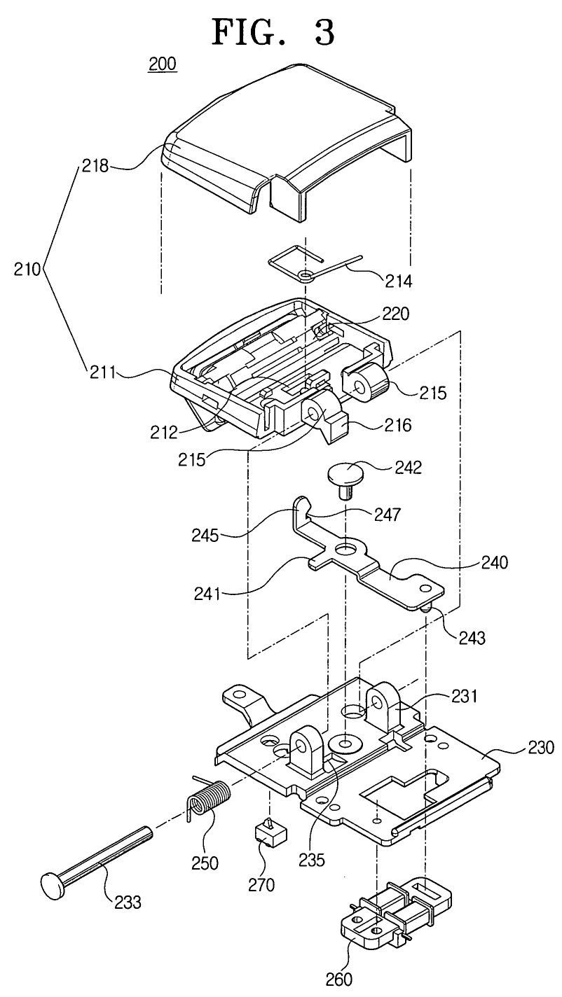

FIG. 1 is an exemplary embodiment of a photographing apparatus having a pop-up flash. FIGS. 2-3 illustrate a pop-up flash according to another embodiment of the present invention.

Referring to FIGS. 1-3, the pop-up flash 200 includes a flash body 210, a pop-up frame 230, a locking lever 240, a locking member 260 and a resilient member 250.

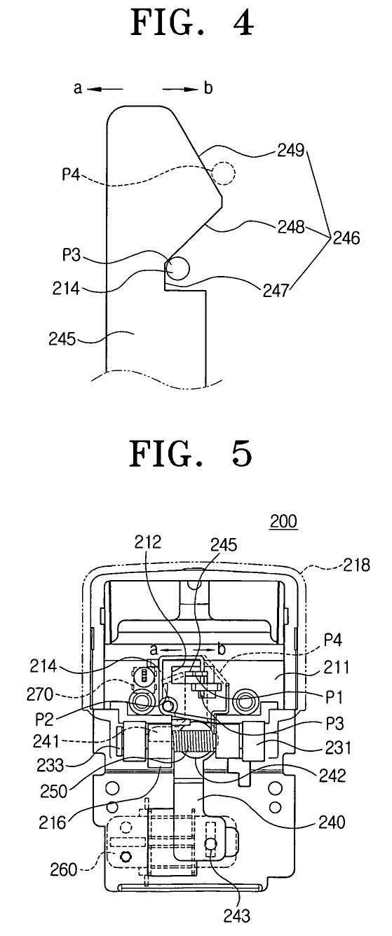

The flash body 210 includes a light emitting portion 220 to generate illuminating light, and a front cover 211 encloses a lens of the light emitting portion 220. Additionally, a rear cover 218 encloses a rear portion of the light emitting portion 220. The flash body 210 is hingedly engaged to the pop-up frame 230 so that the flash body 210 is pivotally engaged to a body 100 of the photographing apparatus. In this embodiment, a pair of hinge bosses 215 protrude from one side of the front cover 211, and hingedly engage the front cover 211 to the pop-up frame 230. Preferably, a return boss 216 further protrudes from at least one of the hinge bosses 215, which will be described hereinafter, and a detailed description thereof is omitted at this time for clarity and conciseness. The front cover 211 of the flash body 210 is formed with a through-hole 212 having a predetermined length. The through-hole 212 accommodates a locking pin 214 hooked to a locking boss 245. The locking pin 214 is preferably made of a resilient material, and resiliently moves between a position P3 (see FIG. 5) at which the locking pin 214 is engaged to the locking boss 245 and a position P4 (see FIG. 5) at which the locking pin 214 is detached from the locking boss 245.

The pop-up frame 230 is fixed to the body 100 of the photographing apparatus, and includes a pair of hinge supports 231 protruding from an upper portion of the pop-up frame 230. The hinge supports 231 are pivotally engaged to the hinge bosses 215 via a hinge shaft 233. In this embodiment, the pop-up frame 230 is preferably molded by a metal die casting such as aluminum alloy. Accordingly, the hinge supports 231 may be formed at any position of the upper portion of the pop-up frame 230. Conventional pop-up frames are formed by sheet metal. This design is limited because the hinge boss is only formed on a rim of the pop-up frame. The pop-up frame of the exemplary embodiment overcomes this design limitation. The pop-up frame of the exemplary embodiment provides strength and rigidity to the pop-up frame and prevents weakening thereof.

The pop-up frame 230 is provided with a retractive groove 235 so that the return boss 216 of the body 210 retracts during the pop-up operation of the pop-up flash. The retractive groove 235 is relatively easily formed on the pop-up frame 230 since it is also preferably made by die casting. Accordingly, the resilient member 250 is installed on the hinge shaft 233 to resiliently urge the flash body 210 to the raised position.

The locking lever 240 includes the locking boss 245. The locking boss 245 protrudes from one side of the locking lever 240 opposite to the front cover 211 of the flash body 210 when the pop-up flash is in the retracted position. The locking lever 240 is pivotally engaged to the upper surface of the pop-up frame 230 by a hinge pin 242. The locking lever 240 pivotally moves between a first position P1 (see FIG. 5), at which the locking boss 245 is engaged to the locking pin 214, and a second position P2 (see FIG. 5) at which the locking boss 245 is released from the locking pin 214.

As shown in FIG. 4, the locking boss 245 is provided with a contact surface 246. The locking pin 214 contacts with the contact surface 246 of the locking boss 245 when the flash body 210 is pivoted between the retracted position and raised positions. The contact surface 246 has an engaging groove 247 to receive the locking pin 214 when the flash body 210 is at the retracted position. A second inclined surface 249 connects an upper end of the locking boss 245 at an upper end of the engaging groove 247. The engaging groove 247 is provided with a first inclined surface 248 at an upper surface of the engaging groove 247. An inclined angle of the first inclined surface 248 and a resilient force of the locking pin 214 are preferably set so that even though the locking pin 214 is moved by the resilient force of the resilient member 250, the locking boss 245 is not released from the locking pin 214. Detailed functions and constructions of the first and second inclined surfaces 248 and 249, respectively, will be described hereinafter for clarity and conciseness.

The locking member 260 selectively secures the locking lever 240 at a predetermined position. The locking member 260 may manually or automatically operate to restrain the pivotal movement of the locking lever 240 either by hand or by an electrical signal generated by a user to restrain the pivotal movement thereof. In this embodiment, the automatic locking member 260 is utilized. A solenoid 260 is preferably utilized as the locking member. The solenoid 260 is coupled to a coupling pin 243 that protrudes from a lower surface of the locking lever 240 to selectively restrain movement of the coupling pin 243. A sensor 270 confirms whether the flash body 210 is positioned at the retracted position, and the solenoid 260 is controlled by a sensor 270 detecting signal.

Operation of the pop-up flash for the photographing apparatus according to an embodiment of the present invention will now be described with reference to the accompanying drawings.

FIG. 5 shows a coupling state of the locking boss 245 and the locking pin 214 after the flash body 210 is positioned at the retracted position. The solenoid 260 is energized to lock the coupling pin 243. As such, the locking lever 240 is locked at the first position P1.

If the solenoid 260 is de-energized, the locking lever 240 freely pivots, and the locking pin 214 moves due to the resilient force of the resilient member 250 to raise the flash body 210. As such, the locking boss 245 moves in the direction of arrow a. The coupling pin 243 moves up along the first inclined surface 248 (see FIG. 4). The first inclined surface 248 is formed on the upper surface of the engaging groove 247 of the locking boss 245. Thus, the locking boss 245 is moved by the locking pin 214.

After the locking boss 245 is released from the locking pin 214, the flash body 210 completely extends to the raised position by the resilient force of the resilient member 250. At that time, the return boss 216 protrudes from the hinge boss 215 of the flash body 210 and contacts with a return piece 241 of the locking lever 240. Thus, the locking lever 240 pivots to its original position, P1. With this construction, the locking lever 240 is simplified since an additional resilient member to return the locking lever 240 is not necessary.

When the flash body 210 moves from the raised position to the retracted position by the user, the sensor 270 detects movement of the flash body 210 toward the retracted position. As such, the solenoid 260 is energized, and the locking lever 240 is locked. If the flash body 210 is continuously lowered, the locking boss 245 comes in contact with the locking pin 214 through the through-hole 212. At this time, the locking pin 214 moves downwardly along the second inclined surface 249 (see FIG. 4) of the contact surface 246. The locking pin 214 is resiliently moved to a fourth position P4 in a direction of arrow b. When the flash body 210 is continuously lowered, the locking pin 214 is opposite to the engaging groove 247. The locking pin 214 is inserted into the engaging groove 247 by the resilient force of the locking pin 214. Thus, the flash body returns to a third position P3, so that the locking boss 245 is engaged to the locking pin 214. As such, the flash body 210 is fixed to the body 100 of the photographing apparatus, and the pop-up flash is retracted in the body of the photographing apparatus. Consequently, the retracting operation of the flash body 210 is complete.

In this embodiment, although the locking lever and the solenoid are installed in the body of the photographing apparatus, and the locking pin is installed in the flash body, the embodiment of the present invention is not limited thereto. Additional suitable arrangements and constructions may be used. The positions of the locking pin and the locking boss may be altered with respect to each other. Consequently, when the flash body moves to the raised position, the locking lever pivots by the resilient force of the resilient member 250. Thus, the locking boss is released from the locking pin. When the flash body is moved to the retracted position, the locking boss is engaged to the locking pin by the resilient movement of the locking pin.

In addition, although the pivoting movement of the locking lever is restrained by the solenoid in this embodiment, the embodiment of the present invention is not restricted thereto. As aforementioned, the locking lever may be restrained by manual operation of a user or any suitable arrangement and construction may be utilized.

Also, although the locking pin, which is preferably made of a resilient material, is utilized as a member engaging to the locking boss, any member floatable by the contact of the locking boss may be utilized.

Accordingly, the pop-up operation of the flash body is restrained by the locking lever only, and an additional resilient member is not necessary to return the locking lever to its original position. Therefore, the construction of the photographing apparatus is simplified in relation to a conventional pop-up flash, thereby reducing manufacturing costs.

While the invention has been shown and described with reference to certain embodiments thereof, it will be understood by those skilled in the art that various changes in form and details may be made therein without departing from the spirit and scope of the invention as defined by the appended claims.

1. A pop-up flash for a photographing apparatus, comprising:
a flash body to emit an illuminating light, the flash body movable between a retracted position and a raised position;
a locking lever having a locking boss which is engaged to an engaging member formed on one of the flash body and a body of the photographing apparatus so that when the flash body is positioned at the retracted position, and installed to the other of the flash body and the body of the photographing apparatus, the flash body pivotally moves between a first position at which the locking boss is engaged to the flash body and a second position at which the locking boss is released from the flash body;
a resilient member to urge the flash body to the raised position; and
a locking member to lock the locking lever when the flash body is positioned at the retracted position,
wherein the locking member is urged toward the second position when the locking boss contacts with the flash body, and is popped up by the resilient member when the flash body is positioned at the raised position.

2. The pop-up flash according to claim 1, wherein
the locking boss has an engaging groove coupled to the engaging member when the flash body is substantially completely positioned at the retracted position, and
the engaging groove has a first inclined surface to urge the locking lever toward the second position by contacting with the engaging member when the flash body is moved to the raised position.

3. The pop-up flash according to claim 2, wherein
the engaging member includes a locking pin resiliently moved between a third position at which the locking pin is inserted into the engaging groove and a fourth position at which the locking pin is released from the engaging groove, and
the locking boss has a second inclined surface for contacting and guiding the locking pin to the fourth position when the flash body is moved to the retracted position, such that a resilient force of the locking pin is substantially increased before the locking pin is inserted into the engaging groove.

4. The pop-up flash according to claim 2, wherein
the locking lever is installed in the body of the photographing apparatus, and has a return piece that protrudes from a side of the locking lever, and
the return piece urges the locking lever to the first position by contacting with the flash body to be popped up in a state where the locking boss is released from the flash body.

5. The pop-up flash according to claim 2, wherein
the locking member includes a solenoid coupled to one side of the locking lever to lock the locking lever when the locking lever is positioned at the first position and to release the locking lever when the locking lever is moved to the raised position.

6. The pop-up flash according to claim 5, further comprising
a sensor installed to the body of the photographing apparatus for determining whether the flash body is positioned at the retracted position, and
the solenoid selectively locks the locking lever according to a signal of the sensor.

7. The pop-up flash according to claim 2, further comprising
a pop-up frame installed in the body of photographing apparatus to pivotally support the flash body and the locking lever, and
the pop-up frame is shaped by molding.

8. A pop-up flash for a photographing apparatus, comprising:
a flash body to emit an illuminating light, the flash body movable between a retracted position and a raised position;
a locking lever having a locking boss which is engaged to an engaging member formed on one of the flash body and a body of the photographing apparatus so that when the flash body is positioned at the retracted position, and installed to the other of the flash body and the body of the photographing apparatus, the flash body pivotally moves between a first position at which the locking boss is engaged to the flash body and a second position at which the locking boss is released from the flash body;
a resilient member to urge the flash body to the raised position;
the locking boss has an engaging groove coupled to the engaging member when the flash body is substantially completely positioned at the retracted position, and
a locking member to lock the locking lever when the flash body is positioned at the retracted position,
wherein the locking member is urged toward the second position when the locking boss contacts with the flash body, and is popped up by the resilient member when the flash body is positioned at the raised position.

9. The pop-up flash according to claim 8, wherein
the engaging groove has a first inclined surface to urge the locking lever toward the second position by contacting with the engaging member when the flash body is moved to the raised position.

10. The pop-up flash according to claim 9, wherein
the engaging member includes a locking pin resiliently moved between a third position at which the locking pin is inserted into the engaging groove and a fourth position at which the locking pin is released from the engaging groove, and
the locking boss has a second inclined surface for contacting and guiding the locking pin to the fourth position when the flash body is moved to the retracted position, such that a resilient force of the locking pin is substantially increased before the locking pin is inserted into the engaging groove.

11. The pop-up flash according to claim 9, wherein
the locking lever is installed in the body of the photographing apparatus, and has a return piece that protrudes from a side of the locking lever, and
the return piece urges the locking lever to the first position by contacting with the flash body to be popped up in a state where the locking boss is released from the flash body.

12. The pop-up flash according to claim 9, wherein
the locking member includes a solenoid coupled to one side of the locking lever to lock the locking lever when the locking lever is positioned at the first position and to release the locking lever when the locking lever is moved to the raised position.

13. The pop-up flash according to claim 12, further comprising
a sensor installed to the body of the photographing apparatus for determining whether the flash body is positioned at the retracted position, and
the solenoid selectively locks the locking lever according to a signal of the sensor.

14. The pop-up flash according to claim 9, further comprising
a pop-up frame installed in the body of photographing apparatus to pivotally support the flash body and the locking lever, and
the pop-up frame is shaped by molding.

15. A pop-up flash for a photographing apparatus, comprising:
a flash body to emit an illuminating light, the flash body movable between a retracted position and a raised position;
a locking lever having a locking boss which is engaged to an engaging member formed on one of the flash body and a body of the photographing apparatus so that when the flash body is positioned at the retracted position, and installed to the other of the flash body and the body of the photographing apparatus, the flash body pivotally moves between a first position at which the locking boss is engaged to the flash body and a second position at which the locking boss is released from the flash body;
a resilient member to urge the flash body to the raised position;
a pop-up frame installed in the body of photographing apparatus to pivotally support the flash body and the locking lever, and
a locking member to lock the locking lever when the flash body is positioned at the retracted position, wherein the locking member is urged toward the second position when the locking boss contacts with the flash body, and is popped up by the resilient member when the flash
body is positioned at the raised position.
